(19) United States
(12) Patent Application Publication
(10) Pub. No.: US 2013/0209779 A1
(43) Pub. Date: Aug. 15, 2013

(54) THREE-DIMENSIONAL SHAPED ARTICLE, METHOD OF PRODUCING THREE-DIMENSIONAL SHAPED ARTICLE, AND LIQUID COMPOSITE FOR PRODUCING THREE-DIMENSIONAL SHAPED ARTICLE

(71) Applicants: Hironori Iida, Kanagawa (JP); Masakazu Mitsugi, Kanagawa (JP); Shun Yamanoi, Kanagawa (JP); Machiko Mintoya, Tokyo (JP); Seiichiro Tabata, Kanagawa (JP); Shinichiro Yamada, Kanagawa (JP); Takeshi Matsui, Tokyo (JP); Ikuko Tsurui, Kanagawa (JP); Yasuhiro Tanaka, Kanagawa (JP)

(72) Inventors: Hironori Iida, Kanagawa (JP); Masakazu Mitsugi, Kanagawa (JP); Shun Yamanoi, Kanagawa (JP); Machiko Mintoya, Tokyo (JP); Seiichiro Tabata, Kanagawa (JP); Shinichiro Yamada, Kanagawa (JP); Takeshi Matsui, Tokyo (JP); Ikuko Tsurui, Kanagawa (JP); Yasuhiro Tanaka, Kanagawa (JP)

(73) Assignee: SONY CORPORATION, Tokyo (JP)

(21) Appl. No.: 13/567,700

(22) Filed: Aug. 6, 2012

(30) Foreign Application Priority Data
Aug. 10, 2011 (JP) 2011-175278

(51) Int. Cl. C09D 1/00

(52) U.S. Cl. CPC C09D 1/00
USPC 428/312.2; 427/407.1; 106/286.8; 106/287.26

(57) ABSTRACT

Provided is a liquid composite for producing a three-dimensional shaped article, the liquid composite being used in an inkjet printer, the liquid composite including a porous carbon material having a specific surface area value as measured by the nitrogen BET method of 10 m²/g or more, a pore volume as measured by the BJH method of 0.1 cm³/g or more and a pore volume as measured by the MP method of 0.1 cm³/g or more.

### CROSS REFERENCES TO RELATED APPLICATIONS

The present application claims priority to Japanese Priority Patent Application JP 2011-175278 filed in the Japan Patent Office on Aug. 10, 2011, the entire content of which is hereby incorporated by reference.

### BACKGROUND

The present disclosure relates to a three-dimensional shaped article, a method of producing the three-dimensional shaped article, and a liquid composite for producing the three-dimensional shaped article.

Three-dimensional shaping is a technique of producing a desired three-dimensional structure (three-dimensional construction) using various devices. There are various methods of producing the three-dimensional shaped article. As major methods, there are a light shaping method, a sheet lamination shaping method, a powder shaping method, and a direct shaping method. Herein, the light shaping method is to shape a three-dimensional shape having a lamination structure by repeating irradiating a high power laser to a photo curing resin and forming a shape having a certain thickness. The sheet lamination shaping method is to shape a three-dimensional shape by cutting out a thin sheet material into layers, adhering and laminating the layers. The powder shaping method is to shape a three-dimensional shape having a lamination structure by repeating paving a powder material in layers and forming a shape having a certain thickness. In these methods, the excess photo curing resin, sheet material or powder material should be removed in a post processing.

The direct shaping method is to shape a three-dimensional shape by repeating spraying and laminating a liquid material. In particular, the direct shaping method using an ink jet printer provides various advantages in that the apparatus is not large-scaled, less post-processing is conducted, the amount of waste materials is small, and minute three-dimensional shaped articles is favorably formed, since a commercially available inkjet printer is used to move a base as if it is printed on a stage, as compared with other shaping methods. In particular, it is considered that application of the direct shaping method is useful in the field of electronic devices and medical materials in order to simplify the process, decrease costs and control a fine structure.

As a raw material used in the method of producing the three-dimensional shaped article in the direct shaping method, a photo curing liquid resin composition is often used (see, for example, Japanese Unexamined Patent Application Publication No. 2010-155926).

### SUMMARY

In the technology disclosed in the above-mentioned Japanese Unexamined Patent Application Publication, the photo curing liquid resin composition is discharged from a discharge nozzle of an inkjet printer in a desired pattern, a resin thin film layer including the composition (a layer of the photo curing liquid resin composition) is formed, the resin thin film layer is then cured by irradiating curing light from a light source, and the operations are repeated. Accordingly, the curing light should be irradiated many times, which may cause cumbersome operations.

Thus, it is desirable to provide a method of producing a three-dimensional shaped article by simple operations, a three-dimensional shaped article provided by the method of producing the three-dimensional shaped article, and a liquid composite suitable for use with the method of producing the three-dimensional shaped article.

According to a first embodiment of the present disclosure, there is provided a liquid composite configured to be used for producing a three-dimensional shaped article, being used in an inkjet printer. The liquid composite includes a porous carbon material having a specific surface area value as measured by the nitrogen BET method of 10 m²/g or more, a pore volume as measured by the BJH method of 0.1 cm³/g or more and a pore volume as measured by the MP method of 0.1 cm³/g or more.

According to a second embodiment of the present disclosure, there is provided a liquid composite configured to be used for producing a three-dimensional shaped article, being used in an inkjet printer. The liquid composite includes a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m.

According to a third embodiment of the present disclosure, there is provided a liquid composite configured to be used for producing a three-dimensional shaped article, being used in an inkjet printer. The liquid composite includes a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume.

According to a first embodiment of the present disclosure, there is provided a method of producing a three-dimensional shaped article. The method includes discharging the liquid composite according to the first embodiment of the present disclosure from a discharge nozzle of an inkjet printer, and repeating the discharging process one or more times, and thereby constructing a three-dimensional shaped article on a base.

According to a second embodiment of the present disclosure, there is provided a method of producing a three-dimensional shaped article. The method includes discharging the liquid composite according to the second embodiment of the present disclosure from a discharge nozzle of an inkjet printer, and repeating the discharging process one or more times, and thereby constructing a three-dimensional shaped article on a base.

According to a third embodiment of the present disclosure, there is provided a method of producing a three-dimensional shaped article. The method includes discharging the liquid composite according to the third embodiment of the present disclosure from a discharge nozzle of an inkjet printer, and repeating the discharging process one or more times, and thereby constructing a three-dimensional shaped article on a base.

According to a first embodiment of the present disclosure, there is provided a three-dimensional shaped article including a porous carbon material having a specific surface area value as measured by the nitrogen BET method of 10 m²/g or more, a pore volume as measured by the BJH method of 0.1 cm³/g or more and a pore volume as measured by the MP method of 0.1 cm³/g or more, in which the three-dimensional shaped article is formed on a base.

According to a second embodiment of the present disclosure, there is provided a three-dimensional shaped article including a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m, in which the three-dimensional shaped article is formed on a base.

According to a third embodiment of the present disclosure, there is provided a three-dimensional shaped article including a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume, in which the three-dimensional shaped article is formed on a base.

The present disclosure defines the specific surface area value of the porous carbon material used, the pore volume value of each kind of the pores, and the pore distribution. In other words, according to an embodiment of the present disclosure, the liquid composite is prepared based on the porous carbon material having the specific pore structure, so that it is possible to discharge the liquid composite stably, and various three-dimensional shaped articles, having a columnar shape and so on, can be easily produced. It may be considered that since the porous carbon material having the specific fine structure is used as the raw material, a solvent contained in the liquid composite is suitably evaporated and diffused, whereby the desired three-dimensional shaped article can be produced.

Additional features and advantages are described herein, and will be apparent from the following Detailed Description and the figures.

### BRIEF DESCRIPTION OF THE FIGURES

FIG. 1 includes photographs of three-dimensional shaped articles provided by using the liquid composite according to Example 1 and Comparative Example 1;

FIGS. 2A and 2B are photographs of three-dimensional shaped articles provided by using the liquid composite according to Example 1;

FIG. 3 is a graph showing an accumulated pore volume measurement result of the porous carbon material in Example 1;

FIG. 4 is a graph showing an accumulated pore volume measurement result of the porous carbon material in Example 1; and

FIG. 5 is a graph showing a pore distribution measurement result of the porous carbon material in Example 1 determined by the Non Localized Density Functional Theory.

### DETAILED DESCRIPTION

Hereinafter, embodiments of the present disclosure will be described with reference to the drawings. The present disclosure is not limited to the embodiments, and various numerical values and materials mentioned in the description of the embodiments are merely examples. The embodiments will be described in the following order.

1. A three-dimensional shaped article, a method of producing the three-dimensional shaped article, and a liquid composite for producing the three-dimensional shaped article according to the first to third embodiments of the present disclosure, general description

2. Example 1 (the three-dimensional shaped article, the method of producing the three-dimensional shaped article, and the liquid composite for producing the three-dimensional shaped article according to the first to third embodiments of the present disclosure), and other

[A Three-Dimensional Shaped Article, a Method of Producing the Three-Dimensional Shaped Article, and a Liquid Composite for Producing the Three-Dimensional Shaped Article According to the First to Third Embodiments of the Present Disclosure, General Description]

In the liquid composite according to the first to third embodiments of the present disclosure, the liquid composite for producing the three-dimensional shaped article according to the first to third embodiments of the present disclosure (hereinafter collectively referred to as “the liquid composite etc. according to an embodiment of the present disclosure”) or the three-dimensional shaped article according to the first to third embodiments of the present disclosure, one of the raw materials of the porous carbon material is a plant-based material containing 5% by mass or more of silicon.

The liquid composite etc. according to an embodiment of the present disclosure, including the above-described favorable embodiments, may further contain various surfactants including ethylene oxide such as acethylenediol and the like, penetrants as typified by 1,2-alcanediol such as 1,2-pentanediol, 1,2-hexanediol and the like (such surfactants and penetrants are used to control wettability of the liquid composite etc. according to an embodiment of the present disclosure) or humectants such as glycerin, 1,3-butanediol, 1,5-pentanediol and the like (which are used to prevent a discharge nozzle of an inkjet printer from drying, and improve discharging properties of the liquid composite etc. according to an embodiment of the present disclosure). As a solvent, water or a water-soluble solvent containing a humectant such as glycerin, 1,3-butanediol, 1,5-pentanediol and the like can be cited. The surfactant or the penetrant may be included in the solvent in some cases. The liquid composite etc. according to the present disclosure may not need a curing agent that is cured by applying heat or light.

In the liquid composite or the method of producing the three-dimensional shaped article according to the first to third embodiments of the present disclosure, including the above-described favorable embodiments and configurations, a cell culture scaffold is composed of the three-dimensional shaped article. In the three-dimensional shaped article according to the first to third embodiments of the present disclosure, including the above-described favorable embodiments and configurations, a cell culture scaffold is composed of the three-dimensional shaped article being formed on a base. The base is not especially limited, the base can be a plastic base, a film or a sheet composed, for example, of polyester resin such as polyethylene terephthalate (PET) and polyethylene naphthalate (PEN); polycarbonate (PC) resin; polyethersulfone (PES) resin; polymethylmethacrylate (PMMA) resin; polyvinylalcohol (PVA) resin; polyvinylphenol (PVP) resin; polyolefin resin such as polystyrene, polyethylene and polypropylene; polyphenylene sulfide resin; vinylidene polyfluoride resin; tetraacetyl cellulose resin; phenoxy bromide resin; aramid resin; polyimide resin; polystyrene resin; polyarylate resin; polysulfone resin; acrylic resin; epoxy resin; fluororesin; silicone resin; diacetate resin; triacetate resin; polyvinyl chloride resin; cyclic polyolefin resin and the like, or can be an inorganic base including a metal, oxide, glass, or quartz base. An example of the glass base includes a soda glass base, a heat-resistant glass base, and a quartz glass base. In addition, the base can be a bone, a nail, a living tissue, a mucous membrane, a skin, a cell sheet, agar, a polymer gel and the like. The three-dimensional shaped article is not limited to the cell culture scaffold, and may be a structure having an electromagnetic wave absorbing effect or an electrode of various sensors.

In the method of producing the three-dimensional shaped article according to the first to third embodiments of the present disclosure, the intended shape of the three-dimensional shaped article is first divided into a plurality of layers to form a shape data, as in the laminating shaping apparatus in the past. Based on the layered shape data, the liquid composite is discharged from the discharge nozzle of the inkjet printer onto the desired place or position, and is dried naturally or forcedly to provide a columnar three-dimensional article. By repeating this, one of thin layers can be formed. In order to connect the columnar three-dimensional articles, the discharge nozzle may be moved at a certain cycle to discharge the liquid composite. By repeating the above, the intended three-dimensional shaped article can be provided. The inkjet printer may have the structure similar to that of the well-known inkjet printer.

As described above, in the liquid composite etc. according to an embodiment of the present disclosure, one of the raw materials of the porous carbon material is favorably the plant-based material containing 5% by mass or more of silicon. Specifically, non-limiting examples of the plant-based material are chaff and straws of rice (paddy), barley, wheat, rye, Japanese millet and foxtail millet; coffee beans; tea leaves (for example, leaves of green tea, black tea and the like); sugar canes (in particular, bagasse); corns (in particular, core of corns); fruit peels (for example, orange peel, banana peel and the like); reeds; Wakame seaweed stems (Undaria pinnatifida); terrestrial vascular plants; ferns; bryophytes; algae; and marine algae. As one of the raw materials, these materials may be used alone, and a plurality of types of such materials may alternatively be used in combination. The shape and the form of the plant-based material are not especially limited. For example, the plant-based material may be chaff or straw itself, or the dried product. In addition, in terms of food processing of beer, liqueur or the like, a residue of various processing including fermentation, roasting, or extracting, can be applied. In particular, from the standpoint of recycling the industrial wastes, it is desirable that chaff and straws after processing, e.g., threshing, are used. These chaff and straws after processing are easily available in large amounts from, for example, agricultural cooperatives, alcoholic beverage makers, food companies and food processing companies.

When one of the raw materials in the porous carbon material of the liquid composite or the three-dimensional shaped article according to an embodiment of the present disclosure (hereinafter referred to as “the porous carbon material according to an embodiment of the present disclosure”) is the plant-based material containing silicon (Si), it is not especially limited, but one of the raw materials of the porous carbon material is the plant-based material containing 5% by mass or more of silicon (Si), and the porous carbon material contains 5% by mass or less of silicon (Si), desirably 3% by mass or less of silicon (Si), and more desirably 1% by mass or less of silicon (Si).

The porous carbon material according to an embodiment of the present disclosure, etc. can be produced, for example, by carbonizing the plant-based material at 400° C. to 1400° C., and then treating the material with acid or alkali. In the method of producing the porous carbon material according to an embodiment of the present disclosure, etc. (hereinafter simply referred to as “the method of producing the porous carbon material”), the material obtained by carbonizing the plant-based material at 400° C. to 1400° C., which is not yet treated with acid or alkali is referred to as “the porous carbon material precursor” or “the carbonaceous substance”.

In the method of producing the porous carbon material, after the acid or alkali treatment, activation treatment can be performed. Or, after the activation treatment, the acid or alkali treatment may be performed. In the method of producing the porous carbon material including the above-described desirable form, although it depends on the plant-based material being used, the plant-based material may be heated (pre-carbonized) at a temperature lower than the carbonizing temperature (for example, at 400° C. to 700° C.) in an oxygen-free state before the plant-based material is carbonized. As a result of extracting a tar component that would be produced during the carbonization, the tar component can be reduced or removed. The oxygen-free state can be achieved by, for example, providing an inert gas atmosphere including a nitrogen gas or an argon gas, providing a vacuum atmosphere, or almost steaming and baking the plant-based material. In the method of producing the porous carbon material, although it depends on the plant-based material being used, the plant-based material may be immersed into alcohols (for example, methyl alcohol, ethyl alcohol and isopropyl alcohol) in order to decrease mineral components and a water content or to prevent odor generation during the carbonization. Also, in the method of producing the porous carbon material, pre-carbonization may be performed thereafter. The plant-based material that produces a large amount of pyroligneous acid (tar and light crude oil) is an example that is desirably heated under the inert gas atmosphere. Seaweeds, which is the plant-based material containing a large amount of iodine and various minerals, is an example that is desirably pretreated with alcohol.

In the method of producing the porous carbon material, the plant-based material is carbonized at 400° C. to 1400° C. The “carbonization” herein means that organic substances (the plant-based material in the porous carbon material according to an embodiment of the present disclosure, etc.) are typically heated to convert them into carbonaceous substance (for example, see JIS M0104-1984). An example of the atmosphere for carbonization is an oxygen-free atmosphere. Specifically, there are a vacuum atmosphere, an inert gas atmosphere including a nitrogen gas or an argon gas, and an atmosphere where the plant-based material is almost steamed and baked. The rate of temperature increase to the carbonization temperature is not limited, but can be 1° C./min or more, desirably 3° C./min or more, more desirably 5° C./min or more under such atmosphere. The upper limit of the carbonization time may be 10 hours, desirably 7 hours and more desirably 5 hours, but not limited to. The lower limit of the carbonization time may be such that the plant-based material is surely carbonized. The plant-based material may be pulverized to the desired particle size, or classified, as necessary. The plant-based material may be pre-cleaned. Also, the resultant porous carbon material precursor or the porous carbon materials may be pulverized to the desired particle size, or classified, as necessary. In addition, the processed porous carbon material by the activation treatment may be pulverized to the desired particle size, or classified, as necessary. Furthermore, the finally resultant porous carbon material may be sterilized. The furnace used for carbonization is not limited in terms of a shape, a configuration and a structure, and may be a continuous furnace or a batch furnace.

In the method of producing the porous carbon material, as described above, the activation treatment can increase the numbers of micro pores each having a pore diameter of not greater than 2 nm (which will be described later). Examples of the activation treatment are gas activation and chemical activation. In the gas activation, oxygen, water vapor, carbon dioxide gas, air or the like can be used as an activator. Under the gas atmosphere, the porous carbon material is heated at 700° C. to 1400° C., desirably 700° C. to 1000° C., more desirably 800° C. to 1000° C. for several tens of minutes to several hours, so that the microstructure is grown by the volatile components and carbon molecules in the porous carbon material. More specifically, the heating temperature may be selected based on the types of the plant-based material, the kinds and concentration of the gas and the like, as necessary. In the chemical activation, the porous carbon material is activated by using zinc chloride, iron chloride, calcium phosphate, calcium hydroxide, magnesium carbonate, potassium carbonate, sulfate or the like is used for activation instead of oxygen and water vapor, and is cleaned with hydrochloric acid. The pH of the porous carbon material is adjusted by using an alkaline solution. Then, the porous carbon material is dried.

The surface of the porous carbon material according to an embodiment of the present disclosure, etc. may be chemical treated or molecular modified. For example, as one of the chemical treatments, a nitric acid treatment is performed to produce carboxyl groups on the surface. By the similar treatment as the activation treatment with water vapor, oxygen, alkali or the like, various functional groups such as a hydroxyl group, a carboxyl group, a ketone group or an ester group can be produced on the surface of the porous carbon material. In addition, when the porous carbon material is chemically reacted with chemical species or protein containing a hydroxyl group, a carboxyl group, an amino group or the like, the molecular modification may be possible.

In the method of producing the porous carbon material, silicon components are removed by the acid or alkali treatment from the carbonized plant-based material. The silicon components may be silicon oxides such as silicon dioxide, silicon oxide and a silicon oxide salt. By removing the silicon components in the carbonized plant-based material, there can be provided the porous carbon material having high specific surface area. In some cases, the silicon components in the carbonized plant-based material may be removed by a dry etching method.

The porous carbon material according to an embodiment of the present disclosure may contain magnesium (Mg), potassium (K), calcium (Ca), non-metal elements such as phosphorous (P) and sulfur (S), and metal elements such as transition elements. The amount of magnesium (Mg) may be from 0.01% by mass to 3% by mass, the amount of potassium (K) may be from 0.01% by mass to 3% by mass, the amount of calcium (Ca) may be from 0.05% by mass to 3% by mass, the amount of phosphorous (P) may be from 0.01% by mass to 3% by mass, and the amount of sulfur (S) may be from 0.01% by mass to 3% by mass, as examples. In terms of an increase in the specific surface area value, the amounts of these elements are desirably small. It should be appreciated that the porous carbon material may contain elements other than those described above, and the amounts thereof may be changed.

In the porous carbon material according to an embodiment of the present disclosure, various elements can be analyzed by, for example, energy dispersive spectrometry (EDS) using an energy dispersive X-ray spectrometer (for example, JED-2200F manufactured by JEOL Ltd). The measurement conditions may include, for example, a scanning voltage of 15 kV and an illumination current of 10 μA.

The porous carbon material according to an embodiment of the present disclosure has many pores. The pores include “mesopores” having a pore diameter in the range from 2 nm to 50 nm, “macropores” having a pore diameter exceeding 50 nm and “micropores” having a pore diameter less than 2 nm. Specifically, the mesopores have many pores having a pore diameter of 20 nm or less, especially 10 nm or less, for example. In the porous carbon material according to an embodiment of the present disclosure, the pore volume as measured by the BJH method is 0.1 cm³/g or more, desirably 0.2 cm³/g or more, more desirably 0.3 cm³/g or more, and even more desirably 0.5 cm³/g or more. The pore volume as measured by the MP method is 0.1 cm³/g or more, desirably 0.2 cm³/g or more, more desirably 0.3 cm³/g or more, and even more desirably 0.5 cm³/g or more. The total pore volume determined by the Non Localized Density Functional Theory, of which the pores have diameters in the range from 1×10⁻⁹ m to 5×10⁻⁷ m is 0.1 cm³/g or more, desirably 0.2 cm³/g or more, more desirably 0.3 of cm³/g or more. The pore diameter distribution determined by the Non Localized Density Functional Theory has at least one peak in the range from 3 nm to 20 nm, in which the ratio of volume of the pores each having a pore diameter in the range from 3 nm to 20 nm is 0.1 or more, desirably 0.2 or more, of the total pore volume.

It is desirable that the porous carbon material according to an embodiment of the present disclosure, etc. desirably has the specific surface area value as measured by the nitrogen BET method (hereinafter may be simply referred to as “the specific surface area value”) of 50 m²/g or more, more desirably 100 m²/g or more, and even more desirably 400 m²/g or more in order to provide higher functionality.

The nitrogen BET method is to measure the adsorption isotherm by adsorbing and desorbing admolecules, i.e. nitrogen, to/from an adsorbent (herein, the porous carbon material), and analyze the measured data by the BET equation represented by the equation (1). Based on the method, the specific surface area value, the pore volume and the like can be calculated. Specifically, when the specific area surface is calculated on the basis of the nitrogen BET method, the adsorption isotherm is first measured by adsorbing and desorbing the admolecules, i.e., nitrogen, to/from the porous carbon material. Then, [p/{Vₐ(p₀−p)}] is calculated from the measured adsorption isotherm based on the equation (1) or the deformed equation (1′) and is plotted to the relative pressure in equilibrium (p/p₀). The plot is considered as a straight line, and the slope s (=[(C−1)/(C Vₘ)]) and the intercept i (=[1/(C Vₘ)]) are calculated based on least squares method. The Vₘ and C are calculated from the calculated slope s and the intercept i based on the equations (2-1) and (2-2). The specific surface area a_{sBET} is calculated from Vₘ based on the equation (3) (see BELSORP-mini and BELSORP analysis software manual, pp. 62-66, made by BEL Japan Inc.). The nitrogen BET method is the measuring method in accordance with JIS R 1626-1996 “Measuring methods for the specific surface area of fine ceramic powders by gas adsorption using the BET method”.

Vₐ=(VₘCp)/[(p−p₀){1+(C−1)(p/p₀)}] (1)

[p/{Vₐ(p₀−p)}]=[(C−1)/(CVₘ)](p/p₀)+[1/(CVₘ)] (1′)

Vₘ=1/(s+i) (2-1)

C=(s/i)+1 (2-2)

a_{sBET}=(VₘLσ)/22414 (3)

where,
Vₐ: Adsorbed amount
Vₘ: Adsorbed amount of monolayer
p: Nitrogen pressure in equilibrium
p₀: Saturated vapor pressure of nitrogen
L: The Avogadro number
σ: Cross-sectional area of adsorbed nitrogen

When the pore volume Vₚ is calculated by the nitrogen BET method, the adsorption data of the measured adsorption isotherm is, for example, linearly interpolated to determine the adsorbed amount V at relative pressure set for calculating the pore volume. The pore volume Vₚ can be calculated from the adsorbed amount V based on the equation (4) (see BELSORP-mini and BELSORP analysis software manual, pp. 62-65, made by BEL Japan Inc.). The pore volume determined by the nitrogen BET method may be referred to simply as “the pore volume”.

Vₚ=(V/22414)×(M_{g}/ρ_{g}) (4)

where,
V: Adsorbed amount at relative pressure
M_{g}: Molecular weight of nitrogen
ρ_{g}: Density of nitrogen

The pore diameter of the mesopores can be calculated as, for example, the pore distribution from the change rate of the pore volume to the pore diameter based on the BJH method. The BJH method is widely used as a method for pore diameter distribution analysis. When the pore diameter distribution is analyzed by the BJH method, the desorption isotherm is first measured by adsorbing and desorbing the admolecules, i.e., nitrogen, to/from the porous carbon material. Then, based on the measured desorption isotherm, the thickness of the adsorbed layer is determined when the adsorbed molecules (for example, nitrogen) that fill the pores are gradually adsorbed/desorbed, and the inner diameter (twice the length of core radius) of the pores is determined. Based on the equation (5), the pore radius rₚ is calculated. Based on the equation (6), the pore volume is calculated. Then, the pore distribution curve is obtained by plotting the change rate of the pore volume (dVₚ/drₚ) to the pore diameter (2rₚ) based on the pore radius and the pore volume (see BELSORP-mini and BELSORP analysis software manual, pp. 85-88, made by BEL Japan Inc.).

rₚ=t+rₖ (5)

Vₚₙ=RₙdVₙ−RₙdtₙcΣAₚⱼ (6)

where,

Rₙ=rₚₙ²/(rₖₙ−1+dtₙ)² (7)

where,
rₚ: Pore radius
rₖ: Core radius (inner diameter/2) when the adsorbed layer having a thickness of t is adsorbed on the inner wall of the pore having the pore radius rₚ at the pressure
Vₚₙ: Pore volume at the time of n-th adsorption/desorption of nitrogen
dVₙ: Amount of change at the time of n-th adsorption/desorption of nitrogen
dtₙ: Amount of change in the thickness tₙ at the time of n-th adsorption/desorption of nitrogen
rₖₙ: Core radius at the time of n-th adsorption/desorption of nitrogen
c: Fixed value
rₚₙ: Pore radius at the time of n-th adsorption/desorption of nitrogen

In addition, ΣAₚⱼ represents the integration value of the areas of the pore walls from j=1 to j=n−1.

The pore diameter of the micropores can be calculated as, for example, the pore distribution from the change rate of the pore volume to the pore diameter based on the MP method. When the pore distribution is analyzed by the MP method, the adsorption isotherm is first measured by adsorbing nitrogen to the porous carbon material. Then, the adsorption isotherm is converted (t plotted) into the pore volume to the thickness t of the adsorbed layer. The pore distribution curve is obtained based on curvature (amount of change in the pore volume to amount of change in the thickness tₙ of the adsorbed layer) of the plot (see BELSORP-mini and BELSORP analysis software manual, pp. 72-73, 82, made by BEL Japan Inc.).

The Non Localized Density Functional Theory (NLDFT) method specified in JIS Z8831-2:2010 “Pore Size Distribution and Porosity of Powders (Solid Materials)—Part 2: Method of Measuring Mesopores and Macropores using Gas Absorption” and JIS Z8831-3:2010 “Pore Size Distribution and Porosity of Powders (Solid Materials)—Part 3: Method of Measuring Micropores using Gas Absorption” employs a software accompanying the automatic specific surface area/pore distribution measuring apparatus “BELSORP-MAX” manufactured by BEL Japan, Inc. as analyzing software. An analysis is carried out using a model having a cylindrical shape and assuming carbon black (CB), as prerequisites for the analysis. Then, a distribution function for pore distribution parameters is set as “no-assumption”, and smoothing will be performed ten times on distribution data thus obtained.

The porous carbon material precursor is treated with an acid or alkali. For example, the porous carbon material precursor may be immersed into a water solution of an acid or alkali. Or, the porous carbon material precursor may be reacted with an acid or alkali in the vapor phase. More specifically, the acid treatment may be carried out using an acidic fluorine compound as an acid such as a hydrogen fluoride, hydrofluoric acid, ammonium fluoride, calcium fluoride, or sodium fluoride. When a fluorine compound is used, the amount of fluorine is desirably four times the amount of silicon in silicon components included in the porous carbon material precursor, and a water solution of the fluorine compound desirably has a concentration of 10% by mass or more. When silicon components (e.g., silicon dioxide) included in the porous carbon material precursor are removed by the use of a hydrofluoric acid, silicon dioxide reacts with the hydrofluoric acid as indicated by formula (A) or (B), and silicon can be eliminated as hydrogen hexafluorosilicate (H₂SiF₆) or silicon tetrafluoride (SiF₄). Thus, a porous carbon material is obtained. The material may thereafter be washed and dried.

SiO₂+6HF→H₂SiF₆+2H₂O (A)

SiO₂+4HF→SiF₄+2H₂O (B)

When the precursor is treated with alkali (base), the alkali may be sodium hydroxide. When a water solution of alkali is used, the pH of the water solution may be 11 or more. When silicon components (e.g., silicon dioxide) included in the porous carbon material precursor are removed by the use of a water solution of sodium hydroxide, silicon dioxide is made to react as indicated by formula (C) by the heating of the water solution of sodium hydroxide. The silicon can be eliminated as sodium silicate (Na₂SiO₃) resulting from the reaction. Thus, a porous carbon material is obtained. When the precursor is treated by the reaction caused by sodium hydroxide in the vapor phase, sodium hydroxide in a solid state is heated to cause it to react as indicated by formula (C). The silicon can be eliminated as sodium silicate (Na₂SiO₃) resulting from the reaction. Thus, a porous carbon material is obtained. The material may thereafter be washed and dried.

SiO₂+2NaOH→Na₂SiO₃+H₂O (C)

The porous carbon material according an embodiment of to the present disclosure may be a porous carbon material including holes having three-dimensional regularity, for example, as disclosed in Japanese Unexamined Patent Application Publication No. 2010-106007 (a porous carbon material having what is called an inverse opal structure). Specifically, the porous carbon material has spherical holes in a three-dimensional arrangement having an average diameter in the range from 1×10⁻⁹ m to 1×10⁻⁵ m and having a surface area of 3×10² m²/g or more. Desirably, the holes are arranged in a disposition similar to a crystalline structure in a macroscopic point of view. Alternatively, the porous carbon material has holes arranged on a surface thereof in a disposition similar to the alignment of a (111) plane of a face-centered cubic structure in a macroscopic point of view.

### Example 1

Example 1 relates to a three-dimensional shaped article according to the first to third embodiments of the present disclosure, a method of producing the three-dimensional shaped article, and a liquid composite for producing the three-dimensional shaped article.

As expressed in accordance with the liquid composite for producing the three-dimensional shaped article according to the first embodiment of the present disclosure, the liquid composite being used in an inkjet printer, the liquid composite for producing the three-dimensional shaped article of Example 1 (which is a sort of ink, hereinafter simply referred to as “the liquid composite of Example 1) includes a porous carbon material having a specific surface area value as measured by the nitrogen BET method of 10 m²/g or more, a pore volume as measured by the BJH method of 0.1 cm³/g or more and a pore volume as measured by the MP method of 0.1 cm³/g or more. As expressed in accordance with the liquid composite for producing the three-dimensional shaped article according to the second embodiment of the present disclosure, the liquid composite being used in an inkjet printer, the liquid composite of Example 1 includes a porous carbon material having a specific surface area value as measured by the nitrogen BET method of 10 m²/g or more, a total pore volume as measured by the Non Localized Density Functional Theory of 0.1 cm³/g or more, of which the pore has a diameter in the range from 1×10⁻⁹ m to 5×10⁻⁷ m.

As expressed in accordance with the liquid composite for producing the three-dimensional shaped article according to the third embodiment of the present disclosure, the liquid composite being used in an inkjet printer, the liquid composite of Example 1 includes a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume.

In Example 1, the raw material is a plant-based material containing 5% by mass or more of silicon. Specifically, the plant-based material which is the raw material of the porous carbon material is rice (paddy) chaff. The porous carbon material of Example 1 is obtained by carbonizing chuff to convert it into a carbonaceous substance (porous carbon material precursor) and thereafter treating the substance with an acid. A method of manufacturing the porous carbon material of Example 1 will be described below.

In the process of manufacturing the liquid composite of the Example 1, the plant-based material was carbonized at a temperature in the range from 400° C. to 1400° C., and was thereafter treated with an acid or alkali, so that the porous carbon material would be obtained. First, a heating process (a preliminary carbonizing process) was performed on chaff under inert gas. Specifically, the chaff was carbonized by the heating at 500° C. for 3 hours in a flow of nitrogen gas, and a carbide was obtained. Such a process makes it possible to reduce or eliminate tar components which will otherwise be generated at a subsequent carbonizing step. Thereafter, 10 grams of the carbide was put in a crucible made of alumina, and the temperature of the carbide was raised to 800° C. at a rate of 5° C./min in a flow of nitrogen gas (5 liters/min). The carbide was carbonized at 800° C. for one hour and converted into a carbonaceous substance (porous carbon material precursor), and the substance was cooled down to room temperature. The nitrogen gas was kept flowing during the carbonization and cooling. Next, the porous carbon material precursor was acid-treated by immersion in a water solution of 46 vol % hydrofluoric acid overnight, and the precursor was washed with water and ethyl alcohol until it reached a pH of 7. Next, the precursor was dried at 120° C. and was then heated to 900° C. in a flow of nitrogen gas. The precursor was activated by heating at 900° C. for 3 hours in a flow of water vapor to provide the porous carbon material of Example 1. The resultant porous carbon material of Example 1 had a silicon (Si) content of not greater than 1% by mass.

Then, based on the obtained porous carbon material, the liquid composites having the compositions shown in Table 1 were prepared. Specifically, the various raw materials shown in Table 1 were prepared by mixing based on ultrasonic irradiation treatment and mechanical agitation treatment. As Comparative Example 1, the liquid composite including self-dispersed active carbon [AquaBlack 162] manufactured by Tokai Carbon Co., Ltd. was used.

TABLE 1
Unit: mass %

| | | Example | | | |
|---|---|---|---|---|---|
| Component | | 1-A | 1-B | 1-C | 1-D |
| Water | | 92.5 | 92.0 | 91.0 | 92.0 |
| Surfactant | E1010 | 1.0 | 1.0 | 1.0 | 1.0 |
| Humectant | 1,5-pentandiol | — | — | — | — |
| | 1,3-butanediol | — | — | — | 3.0 |
| | Glycerin | 3.0 | 3.0 | 3.0 | — |
| Penetrant | 1,2-hexanediol | — | — | — | 3.0 |
| | 1,2-pentanediol | 3.0 | 3.0 | 3.0 | — |
| Porous carbon | | 0.5 | 1.0 | 2.0 | 1.0 |
| Total | | 100.0 | 100.0 | 100.0 | 100.0 |

A nitrogen absorption/desorption test was carried out to find the specific surface areas and the pore volumes, using a measuring apparatus BELSORP-mini (manufactured by BEL Japan, Inc.) The measurement was carried out at a measurement relative pressure in equilibrium (p/p₀) of 0.01 to 0.99. The specific surface areas and the pore volumes were calculated using a BELSORP analysis software. Pore diameter distributions of mesopores and micropores were obtained by conducting a nitrogen absorption/desorption test using the above-mentioned measuring apparatus and carrying out calculations using the BELSORP analysis software based on the BJH method and the MP method. Further, the analysis based on the Non Localized Density Functional Theory (NLDFT) was carried out using a software attached to an automatic specific surface area/pore distribution measuring apparatus “BELSORP-MAX” manufactured by BEL Japan, Inc. Prior to the measurement, the samples were subjected to drying at 200° C. for 3 hours as a pre-process.

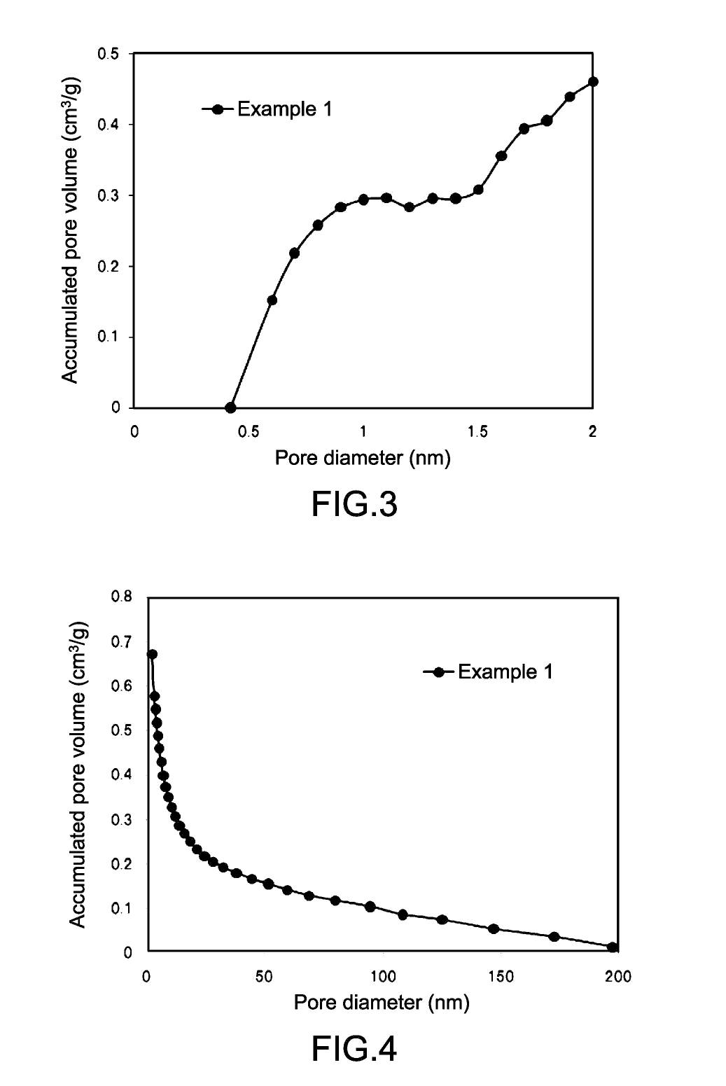

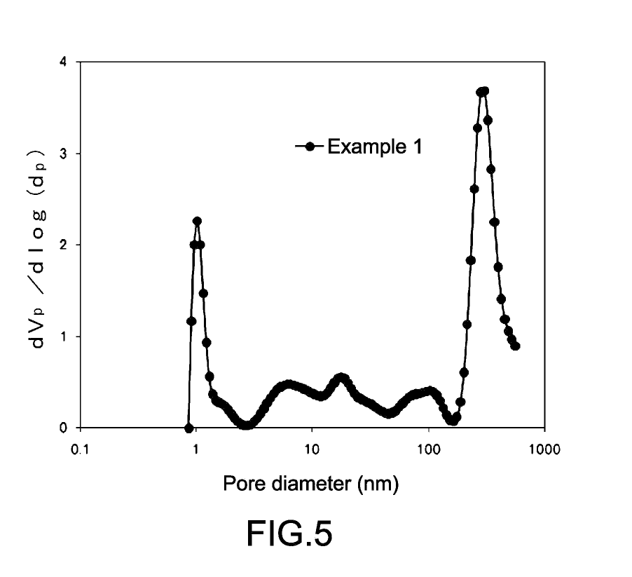

The specific surface area and the pore volume of each of the porous carbon material of Example 1, and carbon black of Comparative Example 1 were measured. Table 2 shows the results. In Table 2, the term “specific surface area” and “total volume of all pores” mean values of a specific surface area and total volume of all pores obtained according to the nitrogen BET method. The units are in m²/g and in cm³/g, respectively. The terms “MP method” and “BJH method” refer to a pore (micropore) volume result measured by the MP method, and a pore (mesopore to macropore) volume result measured by the BJH method, respectively. The units are in cm³/g. FIGS. 3 and 4 show accumulated pore volume measurement results. FIG. 5 shows a pore volume measurement result determined by the Non Localized Density Functional Theory. In the porous carbon material of Example 1 and carbon black of Comparative Example 1, the ratio of the total volume of the pores with diameters in the range from 3 nm to 20 nm was as follows:

Example 1:0.143 (total volume of all pores: 2.182 cm³/gram)

TABLE 2

| | Specific | Total volume | | |
|---|---|---|---|---|
| | surface area | of all pores | MP method | BJH method |
| Example 1 | 1120 | 1.02 | 0.461 | 0.672 |

In the method of producing the three-dimensional shaped article of Example 1, the liquid composite of Example 1 is repeatedly discharged from the discharge nozzle of the inkjet printer a plurality of times to construct the three-dimensional shaped article on the base.

The three-dimensional shaped article of Example 1 includes a porous carbon material having a specific surface area value as measured by the nitrogen BET method of 10 m²/g or more, a pore volume as measured by the BJH method of 0.1 cm³/g or more and a pore volume as measured by the MP method of 0.1 cm³/g or more, and is formed on a base. The three-dimensional shaped article of Example 1 includes a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m, and is formed on a base. The three-dimensional shaped article of Example 1 includes a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume, and is formed on a base.

In Example 1, a commercially available inkjet printer was used. The various liquid composites shown in Table 1 were discharged on inkjet paper used as the base for testing to provide the three-dimensional shaped articles.

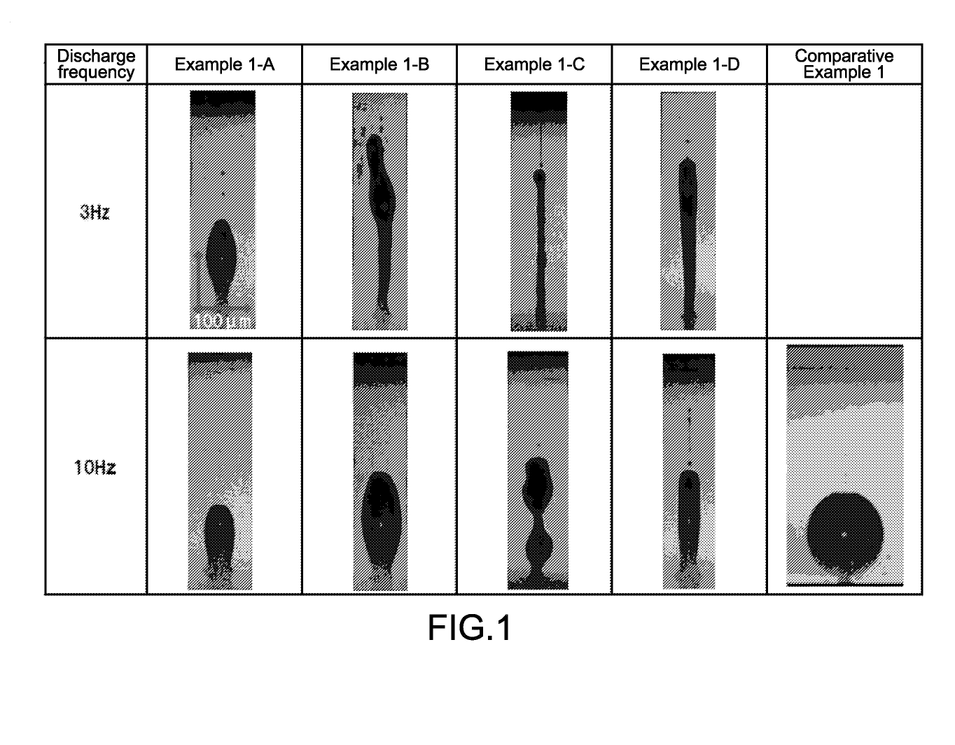

Specifically, columnar three-dimensional shaped articles were provided. Photographs of the resultant three-dimensional shaped articles are shown in FIG. 1. The photographs in FIG. 1 are side views of the three-dimensional shaped articles. In each photograph, the base is disposed downward, and the columnar three-dimensional shaped article is extended almost vertically upward from the base. When the liquid composites in Example 1-A to Example 1-D were used, the columnar three-dimensional shaped articles were provided. On the other hand, when the liquid composite in Comparative Example 1 was used, no columnar three-dimensional shaped article could be provided, a spherical three-dimensional shaped article was provided instead. Thus, the desired three-dimensional shaped article was not provided by the Comparative Example 1.

In the liquid composite in Comparative Example 1, spherical carbon black having a particle size of several to tens nanometers is used as the raw material. When the liquid composite containing the carbon black is discharged, the carbon black is gradually tightly packed as the solvent is dried. As a result, the solvent is inhibited from drying. It is considered that a spherical swelled structure may be easily formed.

On the other hand, when the liquid composites in Example 1-A to Example 1-D are used, the porous carbon materials contained in the liquid composites have well-developed pore structures and irregular surfaces. Therefore, when the liquid composite is discharged and laminated, the solvent is easily penetrated into the base, diffused into air and is easily dried. It is considered that it made the lamination in the columnar shape become possible. As shown in the photograph of the three-dimensional shaped article in FIG. 1 provided by discharging the liquid composite in Example 1-D, it is revealed that the three-dimensional shaped article having a stable columnar shape can be formed by regulating the compositions of the liquid composite.

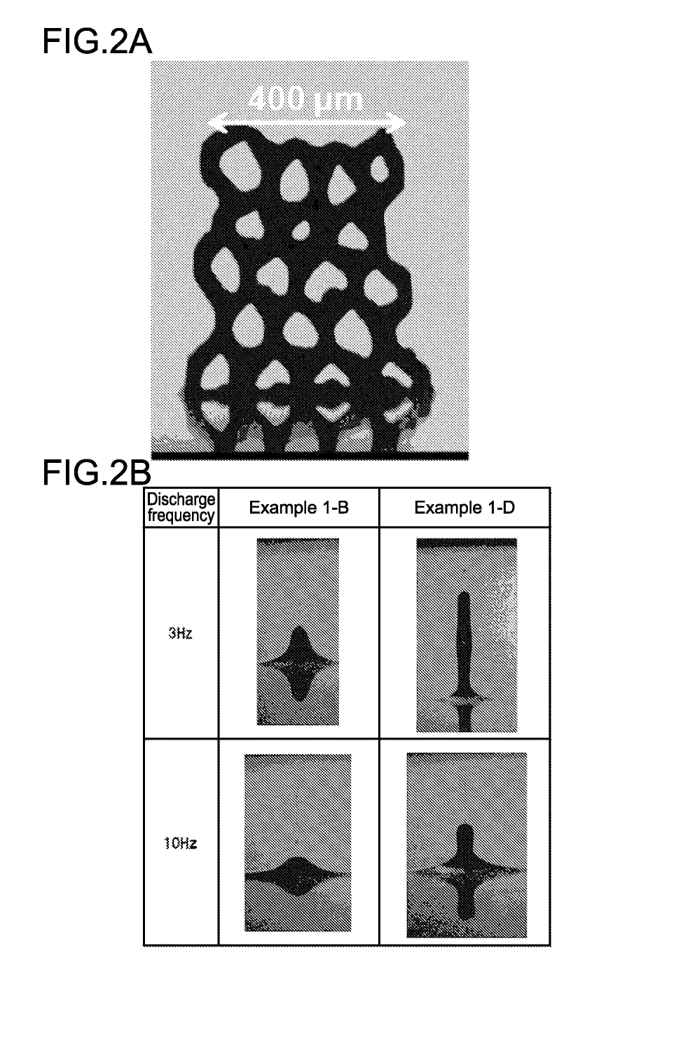

As shown in a side view photograph of the resultant three-dimensional shaped article in FIG. 2A, it is possible to produce the structure by moving a mount used as the base (positioned downward in the photograph) in a horizontal direction (perpendicular to plane of paper in FIG. 2A), when the liquid composite in Example 1-C is being discharged. Further, as shown in side view photographs of the resultant three-dimensional shaped articles in FIG. 2B, it is found that the columnar three-dimensional shaped articles can be formed, when the liquid composites in Example 1-B and Example 1-D are used and the base is a glass base. The glass bases, on which the three-dimensional shaped articles are reflected, are disposed downward in the photographs.

### Example 2

Example 2 is an alternative of Example 1. The three-dimensional shaped article in Example 2 includes a glass base, and forms a cell culture scaffold. In the cell culture scaffold, it is important that emitting substances that are essential components for culture are emitted gradually from the cell culture scaffold heated to around 37° C., which is a culture temperature. Specifically, in Example 2, powder polyacetic acid was mixed with the liquid composite in Example 1-D, and a glass base was used as the base to produce the three-dimensional shaped article as the cell culture scaffold by using the method of producing the three-dimensional shaped article described in Example 1. In general, the cell culture scaffold has a three-dimensional shape including a porous structure. Proteins and the like are adsorbed on, and slowly released from the porous carbon material forming a cell culture material, and cell culture can be easily and reliably performed on the cell culture material. Specifically, cell growth factors that are essential to the cell culture (for example, epidermal growth factor, insulin-like growth factor, transforming growth factor, nerve growth factor and the like) were adsorbed on, and slowly released from the porous carbon material forming the cell culture material, which resulted in efficient cell culture of various cells.

The present disclosure has been described based on the embodiment thereof, and the present disclosure is not limited to the embodiments and may be modified in various ways. While the chaff is used as the raw material of the porous carbon material is made from rice chaff in Examples, other plants may be used. For example, other usable plants include straws, reeds, stems of Wakame seaweed, terrestrial vascular plants, ferns, bryophytes, algae, and marine algae. Those plants may be used alone, and a plurality of types of such plants may alternatively be used in combination. Specifically, chaff of paddy (e.g., Isehikari produced in Kagoshima prefecture in Japan) may be the plant-based material which is the raw material of the porous carbon material. The chaff may be carbonized into a carbonaceous substance (a porous carbon material precursor), and the carbonaceous substance may be treated with an acid to obtain the porous carbon material. Alternatively, gramineous reeds may be the plant-based material is the raw material of the porous carbon material. The gramineous reeds may be carbonized into a carbonaceous substance (a porous carbon material precursor), and the carbonaceous substance may be treated with an acid to obtain the porous carbon material. Advantages similar to those described above were achieved by the porous carbon material obtained by treating a material using alkali (base) such as a water solution of sodium hydroxide instead of a water solution of hydrofluoric acid.

Alternatively, stems of Wakame seaweed (cropped in Sanriku, Iwate prefecture in Japan) may be the plant-based material which is the raw material of the porous carbon material. The stems of Wakame seaweed may be carbonized into a carbonaceous substance (porous carbon material precursor), and the carbonaceous substance may be treated with an acid to obtain the porous carbon material. Specifically, the stems of Wakame seaweed are heated at a temperature of, for example, 500° C. and carbonized. The stems of Wakame seaweed may be treated with alcohol before the heating. Specifically, the raw material may be immersed in ethyl alcohol or the like. As a result, moisture included in the raw material is reduced, and the process also allows elution of elements other than carbon and mineral components which will otherwise be included in the porous carbon material finally obtained. The treatment with alcohol suppresses the generation of gasses during the carbonizing process. More specifically, stems of Wakame seaweed are immersed in ethyl alcohol for 48 hours. It is desirable to perform an ultrasonic process on the material in ethyl alcohol. The stems of Wakame seaweed are then carbonized by being heated at 500° C. for 5 hours in a flow of nitrogen gas to obtain a carbide. Such a process (preliminary carbonizing process) can reduce or eliminate tar components which will otherwise be generated at the subsequent carbonizing step. Thereafter, 10 grams of the carbide is put in a crucible made of alumina, and the temperature of the carbide is raised to 1000° C. at a rate of 5° C./min. in a flow of nitrogen gas (10 liters/min) The carbide is carbonized at 1000° C. for 5 hours and converted into a carbonaceous substance (porous carbon material precursor), and the substance is cooled down to room temperature. The nitrogen gas is kept flowing during the carbonization and cooling. Next, the porous carbon material precursor is acid-treated by immersion in a water solution of 46 vol % hydrofluoric acid overnight, and the precursor is washed with water and ethyl alcohol until it reaches a pH of 7. Finally, the precursor is dried so that a porous carbon material will be obtained.

The present disclosure may have the following configurations.

[1]<<A Liquid Composite: First Embodiment>>

A liquid composite for producing a three-dimensional shaped article, the composite being used in an inkjet printer, the composite including a porous carbon material having a specific surface area value as measured by the nitrogen BET method of 10 m²/g or more, a pore volume as measured by the BJH method of 0.1 cm³/g or more and a pore volume as measured by the MP method of 0.1 cm³/g or more.

[2]<<A Liquid Composite: Second Embodiment>>

A liquid composite for producing a three-dimensional shaped article, the composite being used in an inkjet printer, the composite including a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m.

[3]<<A Liquid Composite: Third Embodiment>>

A liquid composite for producing a three-dimensional shaped article, the composite being used in an inkjet printer, the composite including a porous carbon material having a specific surface area value of 10 m²/g or more as measured by the nitrogen BET method, and at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume.

[4] The liquid composite for producing the three-dimensional shaped article according to any one of [1] to [3] above, in which

one of the raw materials of the porous carbon material is a plant-based material containing 5% by mass or more of silicon.

[5] The liquid composite for producing the three-dimensional shaped article according to any one of [1] to [4] above, further including: a surfactant, a penetrant and a humectant.

[6] The liquid composite for producing the three-dimensional shaped article according to any one of [1] to [5] above, in which

the three-dimensional shaped article is configured to be a component of a cell culture scaffold.

[7]<<A Method of Producing a Three-Dimensional Shaped Article: First Embodiment>>

A method of producing a three-dimensional shaped article, the method including discharging the liquid composite containing a porous carbon material from a discharge nozzle of an inkjet printer, the porous carbon material having a specific surface area value as measured by the nitrogen BET method of 10 m²/g or more, a pore volume as measured by the BJH method of 0.1 cm³/g or more, and a pore volume as measured by the MP method of 0.1 cm³/g or more, and repeating the discharging of the liquid composite one or more times and thereby constructing a three-dimensional shaped article on a base.

[8]<<A Method of Producing a Three-Dimensional Shaped Article: Second Embodiment>>

A method of producing a three-dimensional shaped article, the method including discharging the liquid composite containing a porous carbon material from a discharge nozzle of an inkjet printer, the porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m, and repeating the discharging of the liquid composite one or more times and thereby constructing a three-dimensional shaped article on a base.

[9]<<A Method of Producing a Three-Dimensional Shaped Article: Third Embodiment>>

A method of producing a three-dimensional shaped article, the method including discharging the liquid composite containing a porous carbon material from a discharge nozzle of an inkjet printer, the porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume, and repeating the discharging of the liquid composite one or more times and thereby constructing a three-dimensional shaped article on a base.

[10]<<A Three-Dimensional Shaped Article: First Embodiment>>

A three-dimensional shaped article including a porous carbon material having a specific surface area value as measured by the nitrogen BET method of 10 m²/g or more, a pore volume as measured by the BJH method of 0.1 cm³/g or more, and a pore volume as measured by the MP method of 0.1 cm³/g or more, in which the three-dimensional shaped article is formed on a base.

[11]<<A Three-Dimensional Shaped Article: Second Embodiment>>

A three-dimensional shaped article including a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m, in which the three-dimensional shaped article is formed on a base.

[12]<<A Three-Dimensional Shaped Article: Third Embodiment>>

A three-dimensional shaped article including a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume, in which the three-dimensional shaped article is formed on a base.

[13] The three-dimensional shaped article according to any one of [10] to [12] above, in which

the three-dimensional shaped article is configured to be a component of a cell culture scaffold.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A liquid composite for producing a three-dimensional shaped article, the liquid composite being used in an inkjet printer, the liquid composite comprising:
a porous carbon material having a specific surface area value as measured by the nitrogen BET method of 10 m²/g or more, a pore volume as measured by the BJH method of 0.1 cm³/g or more, and a pore volume as measured by the MP method of 0.1 cm³/g or more.

2. A liquid composite for producing a three-dimensional shaped article, the liquid composite being used in an inkjet printer, the liquid composite comprising:
a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m.

3. A liquid composite for producing a three-dimensional shaped article, the liquid composite being used in an inkjet printer, the liquid composite comprising:
a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume.

4. The liquid composite for producing the three-dimensional shaped article according to claim 1, wherein
a raw material of the porous carbon material is a plant-based material containing 5% by mass or more of silicon.

5. The liquid composite for producing the three-dimensional shaped article according to claim 1, further comprising:
a surfactant, a penetrant and a humectant.

6. The liquid composite for producing the three-dimensional shaped article according to claim 1, wherein
the three-dimensional shaped article is configured to be a component of a cell culture scaffold.

7. A method of producing a three-dimensional shaped article, the method comprising:
discharging a liquid composite containing a porous carbon material from a discharge nozzle of an inkjet printer, the porous carbon material having a specific surface area value as measured by the nitrogen BET method of 10 m²/g or more, a pore volume as measured by the BJH method of 0.1 cm³/g or more, and a pore volume as measured by the MP method of 0.1 cm³/g or more; and
repeating the discharging process one or more times and thereby constructing a three-dimensional shaped article on a base.

8. A method of producing a three-dimensional shaped article, the method comprising:
discharging a liquid composite containing a porous carbon material from a discharge nozzle of an inkjet printer, the porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m; and
repeating the discharging process one or more times and thereby constructing a three-dimensional shaped article on a base.

9. A method of producing a three-dimensional shaped article, the method comprising:
discharging a liquid composite containing a porous carbon material from a discharge nozzle of an inkjet printer, the porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume; and
repeating the discharging process one or more times and thereby constructing a three-dimensional shaped article on a base.

10. A three-dimensional shaped article, comprising:
a porous carbon material having a specific surface area value as measured by the nitrogen BET method of 10 m²/g or more, a pore volume as measured by the BJH method of 0.1 cm³/g or more, and a pore volume as measured by the MP method of 0.1 cm³/g or more,
the three-dimensional shaped article being formed on a base.

11. A three-dimensional shaped article, comprising:
a porous carbon material having a specific surface area value as measured by the nitrogen BET method of 10 m²/g or more, and a total pore volume determined by the Non Localized Density Functional Theory of 0.1 cm³/g or more of which the pores have diameters in the range from 1×10⁻⁹ m to 5×10⁻⁷ m,
the three-dimensional shaped article being formed on a base.

12. A three-dimensional shaped article, comprising:
a porous carbon material having a specific surface area value of 10 m²/g or more as measured by the nitrogen BET method, at least one peak in a pore diameter distribution determined by the Non Localized Density Functional Theory in the range from 3 nm to 20 nm, and a ratio of the total volume of the pores with diameters in the range from 3 nm to 20 nm, being 0.1 or more of the total pore volume,
the three-dimensional shaped article being formed on a base.

13. The three-dimensional shaped article according to claim 10, wherein
the three-dimensional shaped article is configured to be a component of a cell culture scaffold.
